(19) United States
(12) Patent Application Publication
(10) Pub. No.: US 2015/0058357 A1
(43) Pub. Date: Feb. 26, 2015

(54) RATINGS WEIGHTED OR FILTERED BY CONTEXT

(71) Applicant: Google Inc., Mountain View, CA (US)

(72) Inventors: Dean Kenneth Jackson, Pittsburgh, PA (US); Daniel Victor Klein, Pittsburgh, PA (US)

(73) Assignee: Google Inc., Mountain View, CA (US)

(21) Appl. No.: 13/668,130

(22) Filed: Nov. 2, 2012

(51) Int. Cl. G06F 17/30

(52) U.S. Cl. 707/748; 707/E17.033; 707/E17.018

(57) ABSTRACT

The subject technology discloses configurations for accessing one or more entries of rating information for a place associated with a geographical location; identifying, using one or more criteria, a type of user that authored each of the accessed one or more entries of rating information for the place; for a user viewing the one or more entries of rating information for the place, identifying, using one or more criteria, a type of user that is viewing the accessed one or more entries of rating information for the place; filtering the accessed one or more entries of rating information for the place according to the type of user that authored each of the accessed entries and the type of user that is viewing the accessed entries; and providing for display the filtered one or more entries of rating information for the place.

### BACKGROUND

Some web sites enable visitors to provide ratings at a geographical location, such as for a place of business. The subjective quality of the place of business may be assessed based on the ratings. However, such web sites may provide ratings that are not sorted according to the particular needs of a user. Thus, the ratings that are provided may not be relevant to the user based on one or more factors that are of interest to the user.

### SUMMARY

The subject technology includes a machine-implemented method that provides accessing one or more entries of rating information for a place associated with a geographical location in which the rating information includes a numerical score corresponding to the geographical location; identifying, using one or more criteria, a type of user that authored each of the accessed one or more entries of rating information for the place; for a user viewing the one or more entries of rating information for the place, identifying, using one or more criteria, a type of user that is viewing the accessed one or more entries of rating information for the place; filtering the accessed one or more entries of rating information for the place according to the type of user that authored each of the accessed entries and the type of user that is viewing the accessed entries; and providing for display the filtered one or more entries of rating information for the place. The geographical location includes location information that identifies the location of the place.

The type of user that authored each of the accessed one or more entries of rating information for the place includes a local user, non-local user, tourist, business traveler, seasonal traveler, regular traveler, international traveler, national traveler, a regional traveler, occasional traveler, vacation traveler, college traveler, college student, college student on summer break, young traveler, retiree traveler, traveler travelling with children, traveler traveling with adults, or traveler traveling alone. In some configurations, filtering the accessed one or more entries of rating information for the place includes determining if the type of user that authored each of the accessed entries matches the type of user viewing the access entries.

The method further includes assigning a weight for each of the accessed one or more entries of rating information for the place according to the type of user that authored each of the accessed entries and the type of user that is viewing the accessed entries; and determining a weighted average based the numerical score of each of the accessed one or more entries and the assigned weights for each of the accessed one or more entries. The method further includes providing for display the weighted average. A value of the assigned weight for a respective accessed entry indicates a relative importance of the respective accessed entry. The method further includes tagging the type of user that authored each of the accessed one or more entries of rating information for the place. In some examples, the rating information includes data that provides an opinion for the place, or a fixed time, such as noon.

In some configurations, identifying, using one or more criteria, the type of user that authored each of the accessed one or more entries of rating information for the place includes determining at least one of a geographical location of the user, a distance in which the user has traveled, a frequency in which the user provides rating information for places, if the user is a new reviewer, a home location of the user, a geographical location or region in which a majority of the user's submissions of rating information occur, a period of time in which the user travels, if the user has submitted other previous rating information for a city or region associated with the place, a historical record of locations in which the user has traveled, a time when an entry of rating information is submitted, or a meal time during a day derived from an entry of rating information.

The subject technology includes a machine-implemented method that provides for accessing one or more entries of rating information for a place associated with a geographical location in which the rating information includes a numerical score corresponding to the geographical location; determining, using one or more criteria, a respective period of time associated with each of the accessed one or more entries of rating information for the place; filtering the accessed one or more entries of rating information for the place based on the respective period of time associated with each of the accessed one or more entries of rating information for the place; and providing for display the filtered one or more entries of rating information for the place based on the respective period of time. The respective period of time may correspond with a meal time during a day.

In some configurations, filtering the accessed one or more entries of rating information for the place includes determining if the respective period of time associated with each of the accessed one or more entries of rating information matches a specified period of time. Additionally, determining, using the one or more criteria, the period of time associated with each of the accessed one or more entries of rating information for the place includes determining a geographical location of a user that authored each of the accessed one or more entries of rating information for the place; determining a frequency in which the user provides rating information for places; and determining if the place was recently rated by a user.

The method further includes assigning a weight for each of the accessed one or more entries of rating information for the place according to the period of time associated with each of the accessed one or more entries of rating information for the place; and determining a weighted average based the numerical score of each of the accessed one or more entries and the assigned weights of each of the accessed one or more entries. The method then provides for display the weighted average.

The subject technology further includes a system. The system includes memory, one or more processors, one or more modules stored in memory and configured for execution by the one or more processors. The system includes a tagging module configured to access one or more entries of rating information for a place associated with a geographical location in which the rating information includes a numerical score corresponding to the geographical location, identify, using one or more criteria, a type of user that authored each of the accessed one or more entries of rating information for the place, and for a user viewing the one or more entries of rating information for the place, identify, using one or more criteria, a type of user that is viewing the accessed one or more entries of rating information for the place. The system further includes a filtering module configured to filter the accessed one or more entries of rating information for the place according to the type of user that authored each of the accessed entries and the type of user that is viewing the accessed entries. The system includes a graphical user interface (GUI) display module configured to provide for display the filtered one or more entries of rating information for the place.

The system of further includes a weighting module configured to assign a weight for each of the accessed one or more entries of rating information for the place according to the type of user that authored each of the accessed entries and the type of user that is viewing the accessed entries, and determine a weighted average based the numerical score of each of the accessed one or more entries and the assigned weights for each of the accessed one or more entries. The tagging module is further configured to determine, using one or more criteria, a respective period of time associated with each of the accessed one or more entries of rating information for the place. The filtering module is further configured to filter the accessed one or more entries of rating information for the place based on the respective period of time associated with each of the accessed one or more entries of rating information for the place. The weighting module is further configured to assign a weight for each of the accessed one or more entries of rating information for the place according to the period of time associated with each of the accessed one or more entries of rating information for the place; and determine a weighted average based the numerical score of each of the accessed one or more entries and the assigned weights of each of the accessed one or more entries.

The subject technology further provides a machine-readable medium including instructions stored therein, which when executed by a machine, cause the machine to perform operations including accessing one or more entries of rating information for a place associated with a geographical location in which the rating information includes a numerical score corresponding to the geographical location; identifying, using one or more criteria, a type of user that authored each of the accessed one or more entries of rating information for the place; for a user viewing the one or more entries of rating information for the place, identifying, using one or more criteria, a type of user that is viewing the accessed one or more entries of rating information for the place; determining, using one or more criteria, a respective period of time associated with each of the accessed one or more entries of rating information for the place; filtering the accessed one or more entries of rating information for the place according to the type of user that authored each of the accessed entries and the type of user that is viewing the accessed entries, and the respective period of time associated with each of the accessed one or more entries of rating information for the place; and providing for display the filtered one or more entries of rating information for the place.

These and other implementations may provide one or more of the following advantages. For example, ratings filtered based on a type of user and/or a period of time provide more relevant ratings for the user. Additionally, ratings that are weighted according to a type of user and/or period of time enable the subject technology to provide a more accurate rating according to the user's needs so that a more relevant rating is provided to the user.

It is understood that other configurations of the subject technology will become readily apparent from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The features of the subject technology are set forth in the appended claims. However, for purpose of explanation, several configurations of the subject technology are set forth in the following figures.

FIG. 1 illustrates an example computing environment for accessing a computing system for providing online reviews.

FIG. 2 conceptually illustrates an example process for filtering entries of rating information according to one or more criteria.

FIG. 3 conceptually illustrates an example process for assigning weights to entries of rating information according to a type of user(s).

FIG. 4 conceptually illustrates an example process for filtering entries of rating information according to a period of time.

FIG. 5 conceptually illustrates an example process for assigning weights to entries of rating information according to a period of time.

FIG. 6 conceptually illustrates a system with which some implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, structures and components are shown in block diagram form in order to avoid obscuring the concepts of the subject technology.

An online review system generally provide listings of one or more reviews submitted from respective users for products, services or places. In one example, the online review system may accept reviews from one or more users for geographic locations associated with places such as businesses (restaurants, hotels, grocery stores, etc.), points of interests, tourist attractions, landmarks, or other map points. For instance, an online submission interface may be provided for a user to submit a review. The reviews may be presented via a front-end such as a web site for other users to view. In some configurations, the online review system may work conjunctively with an online maps system so that a user(s) may utilize an electronic map to submit a review(s) and/or view a review(s) for places shown on the electronic map.

The online review system may include an option for attributing a rating (e.g., star rating, numerical score, etc.) to a place that informs users regarding its overall quality. In one example, corresponding ratings for a place are averaged in order to provide an aggregate rating for the place. However, the aggregate rating may be an arithmetic mean of all ratings for the place, which does not factor in criteria, for example, associated with a type of a user that submitted the review, temporal information associated with the review, a type of user that is viewing the review (hereinafter “viewing user” or “viewer”), and/or the content of the review itself. Thus, the aggregate rating may not reflect certain criteria that could be more contextually relevant to the user. By way of example, a viewing user that is interested in having dinner at a restaurant may not be interested in reviews involving lunch at the restaurant. Ratings for lunch at the restaurant therefore may not be relevant. A business traveler may be interested in reviews that meet particular needs of the business traveler, which are different than the needs of a tourist or a person local to the area. Additionally, reviews that are provided for a place may be not sorted or filtered to provide contextually relevant reviews to the viewing user. The viewer user of a given online review system typically has to manually read reviews to find relevant reviews.

To address the aforementioned issues, the subject technology provides configurations for providing ratings for a place that are weighted and/or filtered by context. Each review for the place can be provided in an online review system as an entry of rating information. Initially, the rating information includes data for a review (e.g., textual data) and a numerical score for the place. In one aspect, the subject technology categorizes reviews according a type of reviewer to enable reviews to be filtered according to the type of reviewer. For instance, one or more entries of rating information for a place are accessed. Utilizing one or more criteria (“signals”), a type of user that authored (“authoring user”) each of the accessed entries of rating information is determined. A type of user can include a geographical association based on traveling habits (e.g., local, non-local, tourist, business traveler, seasonal traveler, regular traveler, etc.) in the instance(s) where the user consents to the use of geolocation information, a frequency in which the user submits reviews (infrequently, frequently, new, etc.), and other criteria. By way of example, the type of user can be determined according to one or more of the following criteria:
a geographical location of the user;
a distance in which the user has traveled; this distance may indicate an aggregate metric of travel (e.g., occasional, regular, travel, etc.), how far a user has traveled today, how far today that a user has traveled to get to a location associated with a review, how far a user is from the user's home location, etc.
a frequency in which the user provides rating information for places;
an indication if the user is a new reviewer;
a home location of the user;
check-ins via online social networking services;
a user's presence at pleasure-related locations versus business-oriented locations including a frequency at these aforementioned locations, such as a user's presence at hotels, offices, company buildings, museums, casinos, sports arenas, shopping centers, convention centers, etc.
a geographical location or region in which a majority of the user's submissions of rating information occur;
a period of time in which the user travels;
an indication if the user has submitted other previous rating information for a city or region associated with the place;
a historical record of locations in which the user has traveled;
a time when an entry of rating information is submitted;
a meal time during a day derived from an entry of rating information.

Based on the foregoing criteria, the subject technology determines a type of user to attribute or “tag” each entry of rating information for the place. In this regard, entries of rating information can be filtered according to one or more types of users. In one example, a user that is viewing reviews for the place may selectively configure (e.g., via one or more options) a presentation of reviews according to one or more types of users so that more relevant reviews are presented for viewing. In another example, the subject technology can automatically detect which user types are more relevant for the viewing user and filter the reviews accordingly

In an additional aspect, the subject technology determines a period of time for each entry of rating information in order to derive a temporal-based association for a review. The temporal-based association may include a period of time during the day (e.g., breakfast, lunch, dinner, morning, afternoon, evening, late evening, etc.) or a particular day or days. Ratings for a place therefore may vary depending on a period of time associated with the review. This period of time may correspond to a meal time during a day derived from the review (e.g., derived from the content of the review), or may correspond with a time when the review was submitted. For instance, a place can be rated more highly during the afternoon but rating much lower during the evening, and ratings may differ according to a day in which the review applies. Accordingly, when taking an arithmetic mean of scores for the place to provide an aggregate rating, the aggregate rating of such may not reflect a rating that a viewing user is interested in based on the viewing user's temporal preferences. Thus, the subject technology determines a temporal-based association for each entry of rating information for a place and may assign an appropriate weight to the scores according to the temporal-based association. To accomplish these tasks, the subject technology utilizes one or more criteria to derive a temporal-based association for each of the entries of rating information. By way of the example, the subject technology can utilize one or more of the following criteria:
a geographical location of a user that authored a review for the place—may be determined utilizing location history or geolocation information at the time in which the review was submitted;
a frequency in which the user provides rating information for places—a single review at a time may more likely indicate that the user was recently at the place than if the user is submitting multiple reviews at or within a short time period of each review;
an indication if the place was recently rated by a user;
whether the user was at a mobile or desktop computing device when submitting a review;
an indication of a temporal-based association based on a detection of certain key words or phrases in the text of the review.

To facilitate the above, the subject technology in some instances may prompt a user that submits a review to confirm whether that user was recently at the place. In the instance(s) where the user consents to the use of geolocation information, the subject technology can utilize the geolocation information of the user to make a temporal-based association based on when the geolocation information was collected and the user's geolocation at that time. For instance, if the user's geolocation indicates that the user was near or around a place when a review was submitted, the subject technology may derive that the review was for a period of time when the geolocation was tracked. Based on the above criteria, the subject technology determines a period of time associated with each of the entries of rating information and may tag the entries of rating information to indicate a temporal-based association accordingly. This temporal-based association may indicate a time when each of the entries of rating information were submitted (e.g., based on a timestamp for each entry), or indicate a period of time (e.g., meal time during a day) derived from the respective entry of rating information. In this manner, a user viewing the entries of rating information for the place can selectively filter reviews according to these temporal-based associations in order to provide more contextually relevant reviews.

One or more respective weights may be assigned for one or more entries of rating information for the place according to respective periods of time associated with the entries of rating information. In this manner, a weighted average can be determined based the numerical score of each of entries of rating information and the assigned weights. A weighted average may be expressed by the following mathematical notation in which xᵢ are numerical scores and wᵢ are numerical weights:

$$\overline{x} = \frac{{w}_{1} {x}_{1} + {w}_{2} {x}_{2} + … + {w}_{n} {x}_{n}}{{w}_{1} + {w}_{2} + … {w}_{n}}$$

The numerical weights may be a positive or negative value, normalized to a strictly positive range. In one example, ratings for a period of time in which a user is more interested in (e.g., lunch) may be weighted more than ratings for another period of time in which the user is less interested in (e.g., dinner). Similarly, ratings may be weighted according to the type of user that is associated with the rating. In one example, ratings from business travelers may be weighted more than ratings from locals or tourists. Other ways for assigning weights to ratings can be utilized and still be within the scope of the subject technology.

Additionally, the subject technology is further configured to determine trends in ratings for the place and may choose to present such trends to the user. For instance, by utilizing the aforementioned temporal-based associations, the subject technology may determine that the ratings for the place have trended upward or downward during a particular period of time, or that the place receives higher ratings for a certain period of time during the day or on certain days during the week, etc.

In view of the above, it should be understood that the subject technology can conjunctively or separately filter entries of rating information according to user types or temporally-derived information to provide a flexible and extensible solution for assigning weights to and/or filtering ratings by context. Other criteria for filtering than the aforementioned can be utilized and still be within the scope of the subject technology.

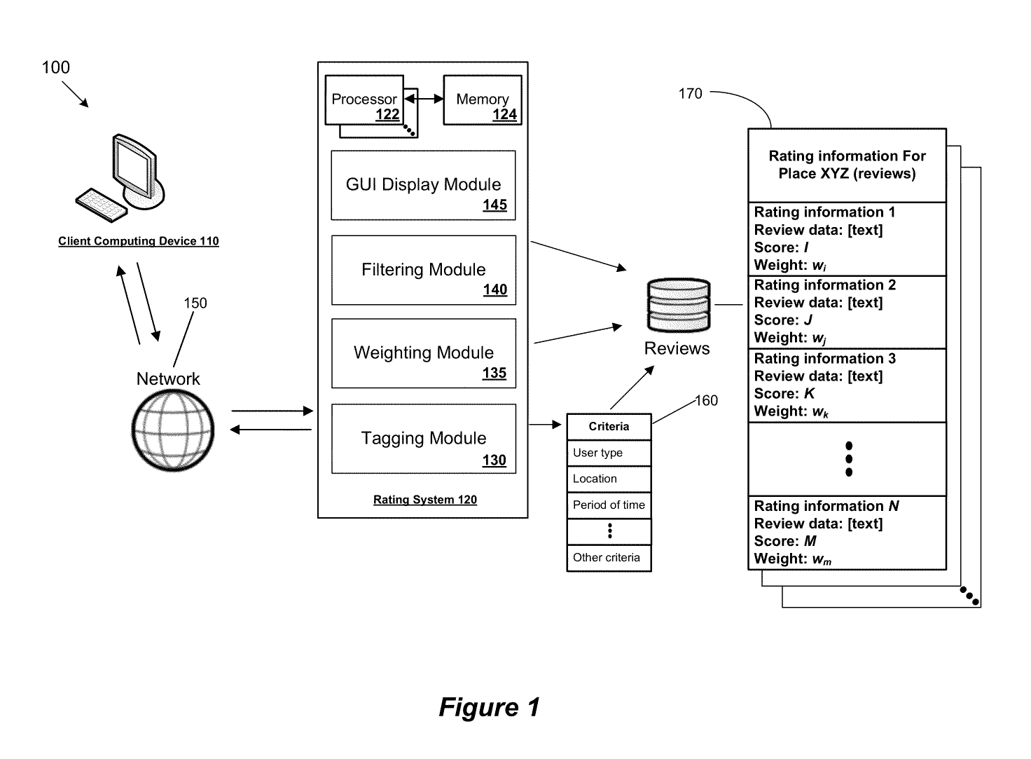

FIG. 1 illustrates an example computing environment 100 for accessing a computing system for providing online reviews. More specifically, the computing environment 100 includes a client computing system 110 and rating system 120. In some configurations, the client computing system 100 may include a mobile device, smartphone, tablet computing device, personal digital assistant, laptop, desktop computing device, etc.

As illustrated in the example of FIG. 1, the client computing system 110 and the rating system 120 are interconnected via a network 150. In one example, the computing system 110 utilizes an appropriate data connection(s) (e.g., HTTP, HTTPS, SMS, MMS, etc.) for communicating with each of the rating system 120. Over such a data connection, the client computing system 110 can transmit and receive data via the network 150 to and from the rating system 120. In some configurations, the network 150 can include, but is not limited to, a local network, remote network, or an interconnected network of networks (e.g., Internet). Similarly, the rating system 120 may be configured to communicate over the network 150 with the client computing system 110 by using any sort of network/communications/data protocol.

In some configurations, the rating system 120 is part of an implementation running a particular machine (e.g., server, one or more computing devices, etc.). The rating system 120 can include memory 124, one or more processors 122, and one or more modules stored in memory and configured for execution by the one or more processors. As shown in FIG. 1, the rating system 120 includes several modules for providing different functionality. The rating system 120 is configured to include a tagging module 130, weighting module 135, filtering module 140 and graphical user interface (GUI) display module 145. These modules of the rating system 120 may access rating information 170 for one or more geographical locations.

Each of the aforementioned modules in the rating system 120 may utilize criteria 160 for processing instances of rating information 170 that correspond with reviews for one or more geographical location(s) as illustrated in FIG. 1. As shown, the criteria 160 may include a user type, location, period of time, and other criteria. The rating information 170 may be locally or remotely stored in memory and/or a storage device (e.g., RAM, hard disk, flash memory, distributed data storage devices, etc.). Further, as shown, each instance of rating information for a particular place may include review data (e.g., text), a score (e.g., a numerical value), and a weight associated with the score. Other types of data may be included in each instance of rating information and still be within the scope of the subject technology. It is also appreciated that not all of the data illustrated in the example of FIG. 1 is required to be included in the instances of rating information.

Each of the aforementioned modules illustrated in FIG. 1 can be configured to communicate between each other. For instance, different data, messages, API calls and returns can be passed between the different modules in the rating system 120.

As illustrated, the tagging module 130 is configured to access one or more entries of rating information for a place associated with a geographical location. The rating information includes a numerical score corresponding to the geographical location. The tagging module 130 is further configured to identify, using one or more criteria, a type of user that authored each of the accessed one or more entries of rating information for the place. For a user viewing the one or more entries of rating information for the place, the tagging module 130 identifies, using one or more criteria, a type of user that is viewing the accessed one or more entries of rating information for the place.

The filtering module 140 is configured to filter the accessed one or more entries of rating information for the place according to the type of user that authored each of the accessed entries and the type of user that is viewing the accessed entries. The GUI display module 145 is configured to provide for display the filtered one or more entries of rating information for the place.

The weighting module 135 is configured to assign a weight for each of the accessed one or more entries of rating information for the place according to the type of user that authored each of the accessed entries and the type of user that is viewing the accessed entries. The weighting module 135 is further configured to determine a weighted average based the numerical score of each of the accessed one or more entries and the assigned weights for each of the accessed one or more entries. The GUI display module 145 is further configured to provide for display the weighted average for the place according to the type(s) of user(s).

The tagging module 130 is further configured to determine, using one or more criteria, a respective period of time associated with each of the accessed one or more entries of rating information for the place. Additionally, the tagging module 130 is configured to tag the type of user that authored each of the accessed one or more entries of rating information for the place. The filtering module 140 is further configured to filter the accessed one or more entries of rating information for the place based on the respective period of time associated with each of the accessed one or more entries of rating information for the place.

The weighting module 135 is further configured to assign a weight for each of the accessed one or more entries of rating information for the place according to the period of time associated with each of the accessed one or more entries of rating information for the place, and determine a weighted average based the numerical score of each of the accessed one or more entries and the assigned weights of each of the accessed one or more entries. In some configurations, the GUI display module 145 is configured to provide for display the weighted average for the place according to the period of time.

Although the example shown in FIG. 1 includes a single rating system 120, the rating system 120 can include a respective cluster of servers/computers that perform a same set of functions provided by the rating system 120 in a distributed and/or load balanced manner. A cluster can be understood as a group of servers/computers that are linked together to seamlessly perform the same set of functions, which can provide performance, reliability and availability advantages over a single server/computer architecture. Additionally, other rating systems may be included in the example computing environment and still be within the scope of the subject technology.

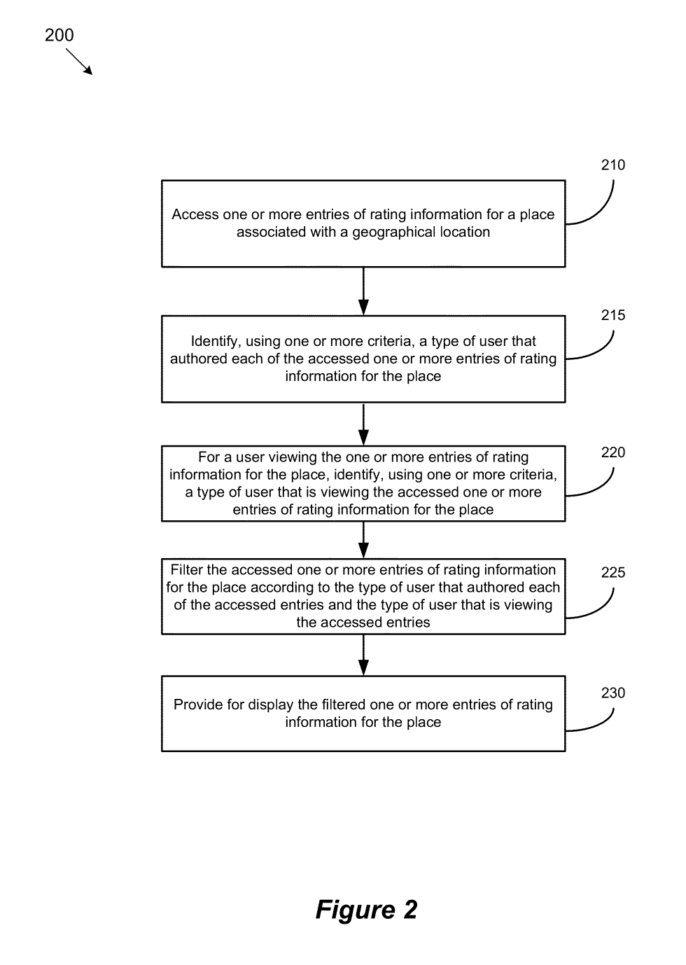

FIG. 2 conceptually illustrates an example process 200 for filtering entries of rating information according to one or more criteria. The process 200 can be performed on one or more computing devices in some configurations.

The process 200 begins at 210 by accessing one or more entries of rating information for a place associated with a geographical location. In one example, the rating information includes a numerical score corresponding to the geographical location (such as a place of business, etc.). The geographical location includes location information that identifies the location of the place in one example. As an example, the rating information includes data that provides an opinion (e.g., a user review) for the place.

The process 200 at 215 identifies, using one or more criteria, a type of user that authored each of the accessed one or more entries of rating information for the place. The type of user that authored each of the accessed one or more entries of rating information for the place may include a local user, non-local user, tourist, business traveler, seasonal traveler, regular traveler, international traveler, national traveler, a regional traveler, occasional traveler, and vacation traveler. Other types of users may be included and still be within the scope of the subject technology.

In some examples, identifying, using one or more criteria, the type of the user that authored each of the accessed one or more entries of rating information for the place may include one or more of the following operations:
determining a geographical location of the user;
determining a distance in which the user has traveled;
determining a frequency in which the user provides rating information for places;
determining if the user is a new reviewer;
determining a home location of the user;
determining a geographical location or region in which a majority of the user's submissions of rating information occur;
determining a period of time in which the user travels; the period of time may specify a period of time such as lunch time (e.g., a meal time), a season such as winter, a span of time such as weekdays, etc.
determining if the user has submitted other previous rating information for a city or region associated with the place;
determining a historical record of locations in which the user has traveled; and
determining a type(s) of business or businesses that the user has reviewed.

At 220, for a user viewing the one or more entries of rating information for the place the process 200 identifies, using one or more criteria, a type of user that is viewing the accessed one or more entries of rating information for the place. The process 200 at 225 filters the accessed one or more entries of rating information for the place according to the type of user that authored each of the accessed entries and the type of user that is viewing the accessed entries. Filtering the accessed one or more entries of rating information for the place may include determining if the type of user that authored each of the accessed entries matches the type of user viewing the access entries. The process 200 may utilize exclusive or inclusive filters. By way of example, an inclusive filter (e.g., for including reviews that match certain criteria) may specify that only lunchtime reviews on weekdays are provided, and an exclusive filter (e.g., for excluding reviews that match certain criteria) may specify that all reviews except for lunchtime reviews on weekdays are provided. At 230, the process 200 provides for display the filtered one or more entries of rating information for the place. The process 200 then ends.

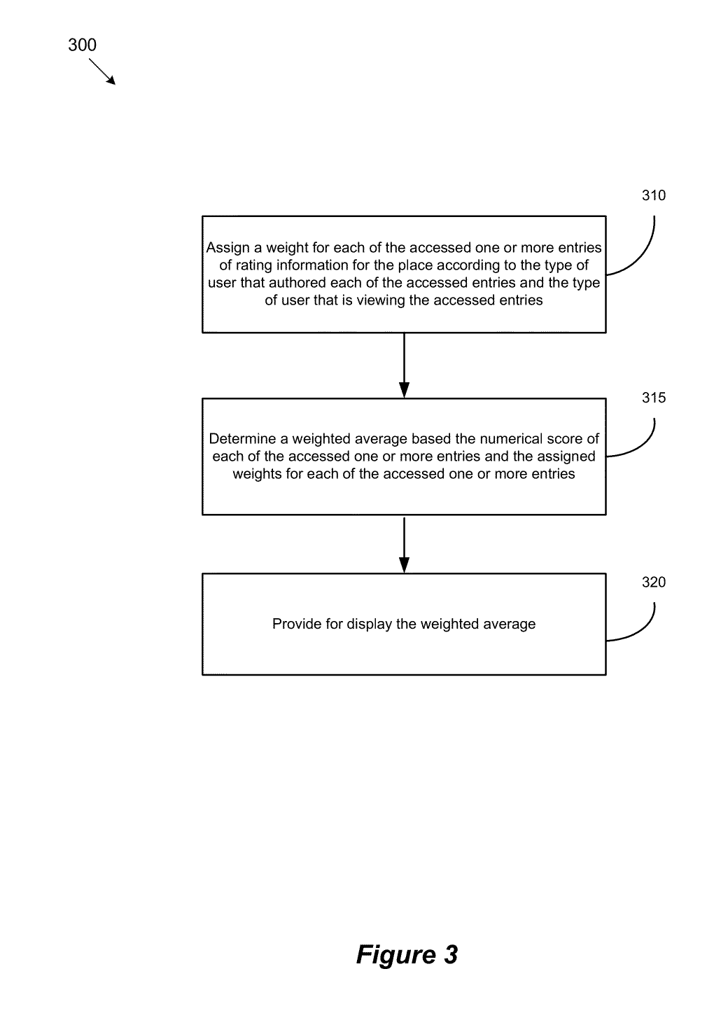

FIG. 3 conceptually illustrates an example process 300 for assigning weights to entries of rating information according to a type of user(s). The process 300 can be performed by one or more computing devices or systems in some configurations.

The process 300 begins at 310 by assigning a weight for each of the accessed one or more entries of rating information for the place according to the type of user that authored each of the accessed entries and the type of user that is viewing the accessed entries. In some examples, a value of the assigned weight for a respective accessed entry indicates a relative importance of the respective accessed entry. The process 300 at 315 determines a weighted average based the numerical score of each of the accessed one or more entries and the assigned weights for each of the accessed one or more entries. Each of the assigned weights may be a positive or negative value, normalized to a strictly positive range. The process 300 at 320 provides for display the weighted average. The process 300 then ends.

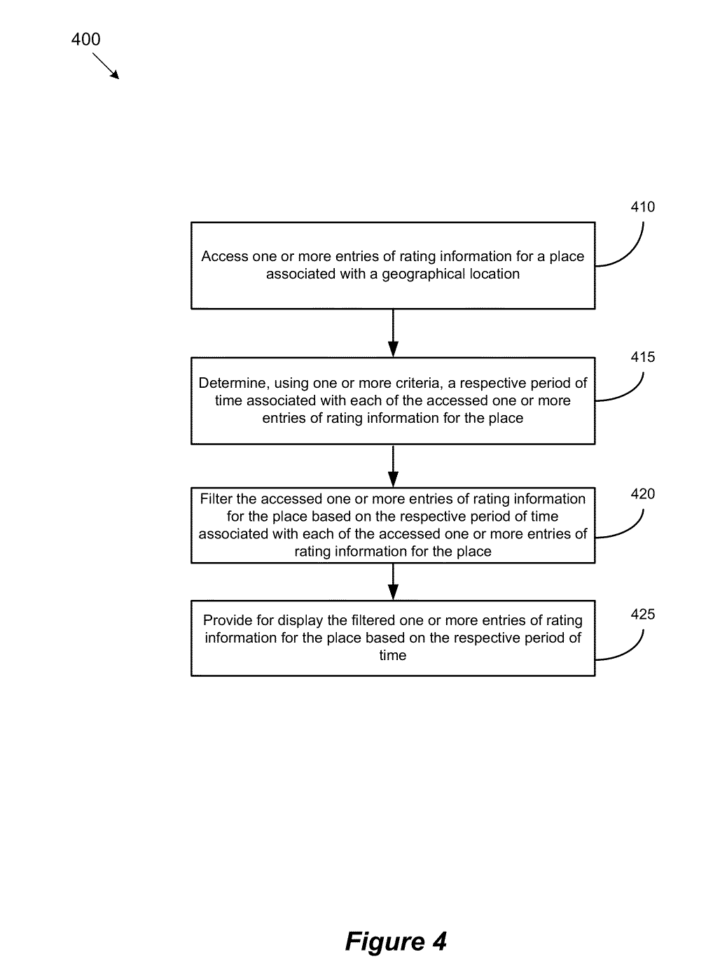

FIG. 4 conceptually illustrates an example process 400 for filtering entries of rating information according to a period of time. The process 400 can be performed by one or more computing devices or systems in some configurations.

The process 400 begins at 410 by accessing one or more entries of rating information for a place associated with a geographical location. The rating information includes a numerical score corresponding to the geographical location. The process 400 at 415 determines, using one or more criteria, a respective period of time associated with each of the accessed one or more entries of rating information for the place. For example, the respective period of time corresponds with a meal time during a day.

In some configurations, determining, using the one or more criteria, the period of time associated with each of the accessed one or more entries of rating information for the place may include one or more of the following operations:
determining a geographical location of a user that authored each of the accessed one or more entries of rating information for the place;
determining a frequency in which the user provides rating information for places; and
determining if the place was recently rated by a user.

At 420, the process 400 filters the accessed one or more entries of rating information for the place based on the respective period of time associated with each of the accessed one or more entries of rating information for the place. Filtering the accessed one or more entries of rating information for the place may include determining if the respective period of time associated with each of the accessed one or more entries of rating information matches a specified period of time. The process 400 may utilize exclusive or inclusive filters. The process 400 at 425 provides for display the filtered one or more entries of rating information for the place based on the respective period of time. The process 400 then ends.

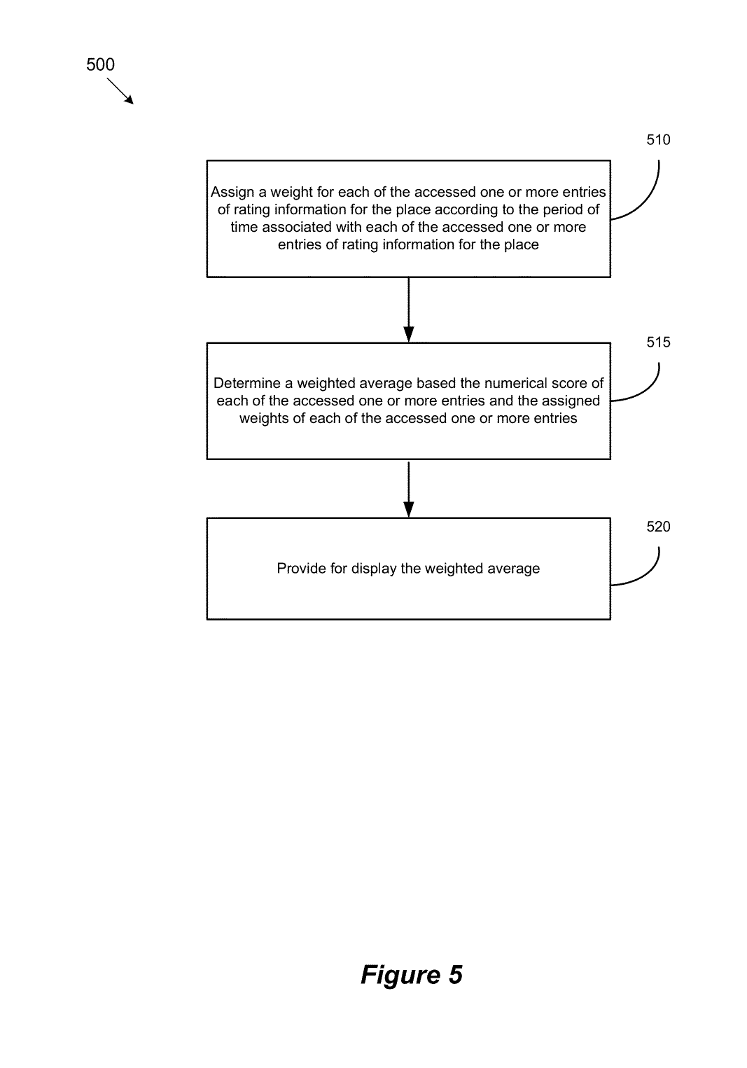

FIG. 5 conceptually illustrates an example process 500 for assigning weights to entries of rating information according to a period of time. The process 500 can be implemented in one or more computing devices in some configurations.

The process 500 begins at 510 by assigning a weight for each of the accessed one or more entries of rating information for the place according to the period of time associated with each of the accessed one or more entries of rating information for the place. The process 500 at 515 determines a weighted average based the numerical score of each of the accessed one or more entries and the assigned weights of each of the accessed one or more entries. Each of the assigned weights may be a positive or negative value, normalized to a strictly positive range. The process 500 at 520 provides for display the weighted average. The process 500 then ends.

Many of the above-described features and applications are implemented as software processes that are specified as a set of instructions recorded on a machine readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of machine readable media include, but are not limited to, CD-ROMs, flash drives, RAM chips, hard drives, EPROMs, disk drives, etc. The machine readable media does not include carrier waves and electronic signals passing wirelessly or over wired connections.

In this specification, the term “software” includes firmware residing in read-only memory and/or applications stored in magnetic storage, which can be read into memory for processing by a processor. Also, in some implementations, multiple software components can be implemented as sub-parts of a larger program while remaining distinct software components. In some implementations, multiple software subject components can also be implemented as separate programs. Finally, a combination of separate programs that together implement a software component(s) described here is within the scope of the subject technology. In some implementations, the software programs, when installed to operate on one or more systems, define one or more specific machine implementations that execute and perform the operations of the software programs.

A computer program (also known as a program, software, software application, script, or code) can be written in a form of programming language, including compiled or interpreted languages, declarative or procedural languages, and it can be deployed in some form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some configurations are implemented as software processes that include one or more application programming interfaces (APIs) in an environment with calling program code interacting with other program code being called through the one or more interfaces. Various function calls, messages or other types of invocations, which can include various kinds of parameters, can be transferred via the APIs between the calling program and the code being called. In addition, an API can provide the calling program code the ability to use data types or classes defined in the API and implemented in the called program code.

The following description describes an example system in which aspects of the subject technology can be implemented.

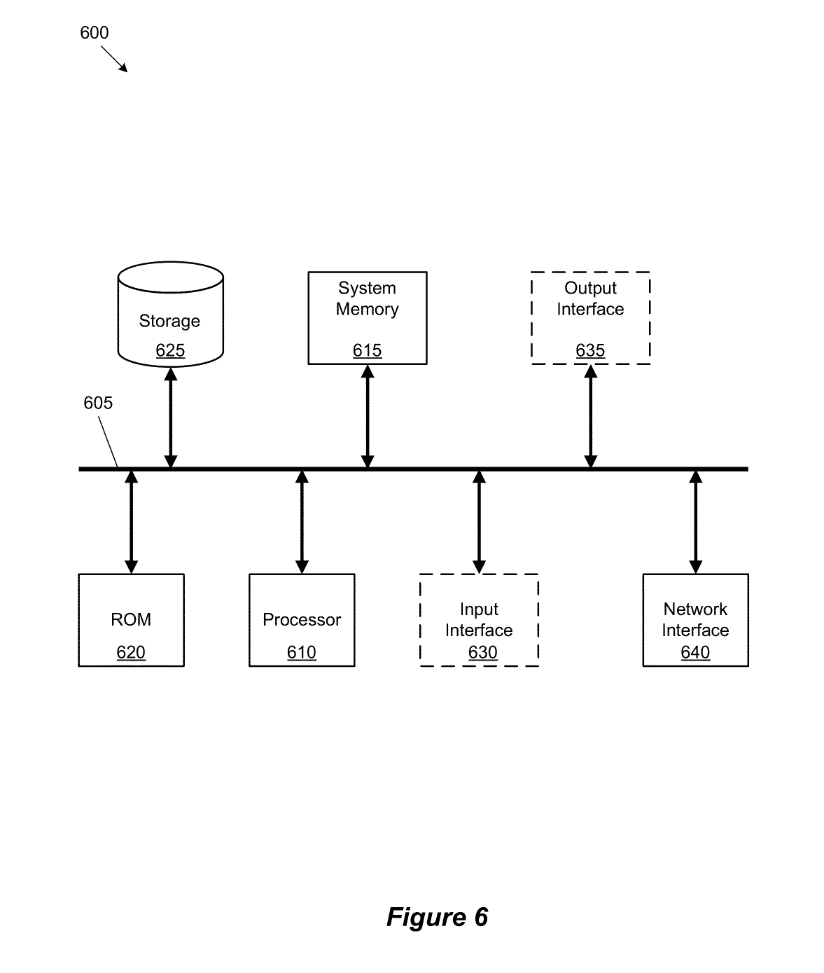

FIG. 6 conceptually illustrates a system 600 with which some implementations of the subject technology can be implemented. The system 600 can be a computer, phone, PDA, or another sort of electronic device. In some configurations, the system 600 includes a television with one or more processors embedded therein. Such a system includes various types of computer readable media and interfaces for various other types of computer readable media. The system 600 includes a bus 605, processing unit(s) 610, a system memory 615, a read-only memory 620, a storage device 625, an optional input interface 630, an optional output interface 635, and a network interface 640.

The bus 605 collectively represents all system, peripheral, and chipset buses that communicatively connect the numerous internal devices of the system 600. For instance, the bus 605 communicatively connects the processing unit(s) 610 with the read-only memory 620, the system memory 615, and the storage device 625.

From these various memory units, the processing unit(s) 610 retrieves instructions to execute and data to process in order to execute the processes of the subject technology. The processing unit(s) can be a single processor or a multi-core processor in different implementations.

The read-only-memory (ROM) 620 stores static data and instructions that are needed by the processing unit(s) 610 and other modules of the system 600. The storage device 625, on the other hand, is a read-and-write memory device. This device is a non-volatile memory unit that stores instructions and data even when the system 600 is off. Some implementations of the subject technology use a mass-storage device (such as a magnetic or optical disk and its corresponding disk drive) as the storage device 625.

Other implementations use a removable storage device (such as a flash drive, a floppy disk, and its corresponding disk drive) as the storage device 625. Like the storage device 625, the system memory 615 is a read-and-write memory device. However, unlike storage device 625, the system memory 615 is a volatile read-and-write memory, such a random access memory. The system memory 615 stores some of the instructions and data that the processor needs at runtime. In some implementations, the subject technology's processes are stored in the system memory 615, the storage device 625, and/or the read-only memory 620. For example, the various memory units include instructions for processing multimedia items in accordance with some implementations. From these various memory units, the processing unit(s) 610 retrieves instructions to execute and data to process in order to execute the processes of some implementations.

The bus 605 also connects to the optional input and output interfaces 630 and 635. The optional input interface 630 enables the user to communicate information and select commands to the system. The optional input interface 630 can interface with alphanumeric keyboards and pointing devices (also called “cursor control devices”). The optional output interface 635 can provide display images generated by the system 600. The optional output interface 635 can interface with printers and display devices, such as cathode ray tubes (CRT) or liquid crystal displays (LCD). Some implementations can interface with devices such as a touchscreen that functions as both input and output devices.

Finally, as shown in FIG. 6, bus 605 also couples system 600 to a network interface 640 through a network adapter (not shown). In this manner, the computer can be a part of a network of computers (such as a local area network (“LAN”), a wide area network (“WAN”), or an Intranet, or an interconnected network of networks, such as the Internet. The components of system 600 can be used in conjunction with the subject technology.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and the claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and the claims of this application, the terms “computer readable medium” and “computer readable media” are entirely restricted to tangible, physical objects that store information in a form that is readable by a computer. These terms exclude wireless signals, wired download signals, and other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be a form of sensory feedback, e.g., visual feedback, auditory feedback, or tactile feedback; and input from the user can be received in a form, including acoustic, speech, or tactile input. In addition, a computer can interact with a user by sending documents to and receiving documents from a device that is used by the user; for example, by sending web pages to a web browser on a user's client device in response to requests received from the web browser.

Configurations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or a combination of one or more such back end, middleware, or front end components. The components of the system can be interconnected by a form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some configurations, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that a specific order or hierarchy of steps in the processes disclosed is an illustration of example approaches. Based upon design preferences, it is understood that the specific order or hierarchy of steps in the processes can be rearranged, or that all illustrated steps be performed. Some of the steps can be performed simultaneously. For example, in certain circumstances, multitasking and parallel processing can be advantageous. Moreover, the separation of various system components in the configurations described above should not be understood as requiring such separation in all configurations, and it should be understood that the described program components and systems can generally be integrated together in a single software product or packaged into multiple software products.

The previous description is provided to enable a person skilled in the art to practice the various aspects described herein. Various modifications to these aspects will be readily apparent to those skilled in the art, and the generic principles defined herein can be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase such as an “aspect” does not imply that such aspect is essential to the subject technology or that such aspect applies to all configurations of the subject technology. A disclosure relating to an aspect can apply to all configurations, or one or more configurations. A phrase such as an aspect can refer to one or more aspects and vice versa. A phrase such as a “configuration” does not imply that such configuration is essential to the subject technology or that such configuration applies to all configurations of the subject technology. A disclosure relating to a configuration can apply to all configurations, or one or more configurations. A phrase such as a configuration can refer to one or more configurations and vice versa.

1. A machine-implemented method, the method comprising:
accessing one or more entries of rating information for a place associated with a geographical location, wherein the rating information includes a numerical score corresponding to the geographical location;
identifying, using one or more criteria, a type of user that authored each of the accessed one or more entries of rating information for the place;
for a user viewing the one or more entries of rating information for the place, identifying, using one or more criteria, a type of user that is viewing the accessed one or more entries of rating information for the place;
determining a respective period of time associated with each of the accessed one or more entries of rating information for the place;
filtering the accessed one or more entries of rating information for the place according to the type of user that authored each of the accessed entries and the type of user that is viewing the accessed entries, and the respective period of time associated with each of the accessed one or more entries of rating information for the place;
determining, based on the respective periods of time, that ratings for the place trended upward or downward during a particular time period;
providing for display of the filtered one or more entries of rating information for the place, wherein the display includes an indication of the determination that ratings for the place trended upward or downward during the particular time period;
assigning, for each of the accessed one or more entries of rating information for the place, a weight for the entry of rating information, wherein the weight is assigned based on at least one of travel habits of a user that authored the entry or a frequency in which the user submits reviews; and
determining a weighted average based on the numerical score of each of the accessed one or more entries and the assigned weights for each of the accessed one or more entries.

2. (canceled)

3. The method of claim 1, wherein a value of the assigned weight for a respective accessed entry indicates a relative importance of the respective accessed entry.

4. The method of claim 1, further comprising:
providing for display of the weighted average.

5. The method of claim 1, further comprising:
tagging the type of user that authored each of the accessed one or more entries of rating information for the place.

6. The method of claim 1, wherein the geographical location includes location information that identifies the location of the place.

7. The method of claim 1, wherein the rating information includes data that provides an opinion for the place.

8. The method of claim 1, wherein identifying, using one or more criteria, the type of user that authored each of the accessed one or more entries of rating information for the place comprises determining at least one of a geographical location of the user, a distance in which the user has traveled, a frequency in which the user provides rating information for places, if the user is a new reviewer, a home location of the user, a geographical location or region in which a majority of the user's submissions of rating information occur, a period of time in which the user travels, if the user has submitted other previous rating information for a city or region associated with the place, a historical record of locations in which the user has traveled, a time when an entry of rating information is submitted, or a meal time during a day derived from an entry of rating information.

9. The method of claim 1, wherein the type of user that authored each of the accessed one or more entries of rating information for the place comprises:
a local user, non-local user, tourist, business traveler, seasonal traveler, regular traveler, international traveler, national traveler, a regional traveler, occasional traveler, vacation traveler, college traveler, college student, college student on summer break, young traveler, retiree traveler, traveler travelling with children, traveler traveling with adults, or traveler traveling alone.

10. The method of claim 1, wherein filtering the accessed one or more entries of rating information for the place comprises:
determining if the type of user that authored each of the accessed entries matches the type of user viewing the accessed entries.

11. A machine-implemented method, the method comprising:
accessing one or more entries of rating information for a place associated with a geographical location, wherein the rating information includes a numerical score corresponding to the geographical location;
identifying, using one or more criteria, a type of user that authored each of the accessed one or more entries of rating information for the place;
for a user viewing the one or more entries of rating information for the place, identifying, using one or more criteria, a type of user that is viewing the accessed one or more entries of rating information for the place;
determining, using one or more criteria, a respective period of time associated with each of the accessed one or more entries of rating information for the place;
filtering the accessed one or more entries of rating information for the place to the type of user that authored each of the accessed entries and the type of user that is viewing the accessed entries, and the respective period of time associated with each of the accessed one or more entries of rating information for the place;
determining, based on the respective periods of time, that ratings for the place trended upward or downward during a particular time period;
providing for display of the filtered one or more entries of rating information for the place, wherein the display includes an indication of the determination that ratings for the place trended upward or downward during the particular time period;
assigning, for each of the accessed one or more entries of rating information for the place, a weight for the entry of rating information, wherein the weight is assigned based on at least one of travel habits of a user that authored the entry or a frequency in which the user submits reviews; and
determining a weighted average based on the numerical score of each of the accessed one or more entries and the assigned weights for each of the accessed one or more entries.

12. The method of claim 11, further comprising:
assigning a weight for each of the accessed one or more entries of rating information for the place according to the period of time associated with each of the accessed one or more entries of rating information for the place; and
determining a weighted average based on the numerical score of each of the accessed one or more entries and the assigned weights of each of the accessed one or more entries.

13. The method of claim 11, wherein determining, using the one or more criteria, the period of time associated with each of the accessed one or more entries of rating information for the place comprises:
determining a geographical location of a user that authored each of the accessed one or more entries of rating information for the place;
determining a frequency in which the user provides rating information for places; and
determining if the place was recently rated by a user.

14. The method of claim 11, wherein the respective period of time corresponds with a meal time during a day.

15. The method of claim 11, wherein filtering the accessed one or more entries of rating information for the place comprises:
determining if the respective period of time associated with each of the accessed one or more entries of rating information matches a specified period of time.

16. A system, the system comprising:
memory;
one or more processors;
one or more modules stored in memory and configured for execution by the one or more processors, the modules comprising:
a tagging module configured to:
access one or more entries of rating information for a place associated with a geographical location, wherein the rating information includes a numerical score corresponding to the geographical location,
identify, using one or more criteria, a type of user that authored each of the accessed one or more entries of rating information for the place,
for a user viewing the one or more entries of rating information for the place, identify, using one or more criteria, a type of user that is viewing the accessed one or more entries of rating information for the place;
determine a respective period of time associated with each of the accessed one or more entries of rating information for the place; and
determine, based on the respective periods of time, that ratings for the place trended upward or downward during a particular time period;
a filtering module configured to filter the accessed one or more entries of rating information for the place according to the type of user that authored each of the accessed entries and the type of user that is viewing the accessed entries, and the respective period of time associated with each of the accessed one or more entries of rating information for the place;
a graphical user interface (GUI) display module configured to provide for display of the filtered one or more entries of rating information for the place, wherein the display includes an indication of the determination that ratings for the place trended upward or downward during the particular time period; and
a weighting module configured to:
assign, for each of the accessed one or more entries of rating information for the place, a weight for the entry of rating information, and
determine a weighted average based on the numerical score of each of the accessed one or more entries and the assigned weights for each of the accessed one or more entries.

17. (canceled)

18. The system of claim 16, wherein the tagging module is further configured to:
determine, using one or more criteria, a respective period of time associated with each of the accessed one or more entries of rating information for the place.

19. The system of claim 18, wherein the filtering module is further configured to:
filter the accessed one or more entries of rating information for the place based on the respective period of time associated with each of the accessed one or more entries of rating information for the place.

20. The system of claim 19, wherein the weighting module is further configured to:
assign the weight for each of the accessed one or more entries of rating information for the place according to the period of time associated with each of the accessed one or more entries of rating information for the place.

21. A machine-readable medium comprising instructions stored therein, which when executed by a machine, cause the machine to perform operations comprising:
accessing one or more entries of rating information for a place associated with a geographical location, wherein the rating information includes a numerical score corresponding to the geographical location;
identifying, using one or more criteria, a type of user that authored each of the accessed one or more entries of rating information for the place;
for a user viewing the one or more entries of rating information for the place, identifying, using one or more criteria, a type of user that is viewing the accessed one or more entries of rating information for the place;
determining a respective period of time associated with each of the accessed one or more entries of rating information for the place;
filtering the accessed one or more entries of rating information for the place according to the type of user that authored each of the accessed entries and the type of user that is viewing the accessed entries, and the respective period of time associated with each of the accessed one or more entries of rating information for the place; and
determining, based on the respective periods of time, that ratings for the place trended upward or downward during a particular time period;
providing for display of the filtered one or more entries of rating information for the place,
wherein the display includes an indication of the determination that ratings for the place trended upward or downward during the particular time period, and
wherein filtering the accessed one or more entries according to the type of user that authored each of the accessed entries is based on at least one of travel habits of the user that authored the entry or a frequency in which the user submits reviews.
